(19) United States
(12) Patent Application Publication
(10) Pub. No.: US 2014/0032667 A1
(43) Pub. Date: Jan. 30, 2014

(54) SYSTEMS AND METHODS FOR ALLOWING A USER TO ENLIST COLLABORATORS IN MAKING A DECISION

(71) Applicant: Betty Wright, Davie, FL (US)

(72) Inventor: Betty Wright, Davie, FL (US)

(21) Appl. No.: 13/948,381

(22) Filed: Jul. 23, 2013

Related U.S. Application Data
(60) Provisional application No. 61/675,425, filed on Jul. 25, 2012.
(60) Provisional application No. 61/677,585, filed on Jul. 31, 2012.

(51) Int. Cl. H04L 29/06

(52) U.S. Cl. CPC H04L 65/403
USPC 709/204

(57) ABSTRACT

A non-transitory computer-readable storage medium including instructions that, when executed by the computing system, performs the step receiving from a user a decision. The decision includes a deadline by which collaborators must respond. The non-transitory computer-readable storage medium also includes instructions that, when executed by the computing system, performs the steps allowing the user to choose collaborators and sending the decision to the collaborators. The non-transitory computer-readable storage medium further includes instructions that, when executed by the computing system, performs the steps receiving results from the collaborators and presenting results from the collaborators to the user.

### CROSS-REFERENCE TO RELATED APPLICATIONS

This application claims the benefit of and priority to U.S. Provisional Patent Application Serial No. 61/675,425 filed on Jul. 25, 2012, which application is incorporated herein by reference in its entirety.

This application claims the benefit of and priority to U.S. Provisional Patent Application Serial No. 61/677,585 filed on Jul. 31, 2012, which application is incorporated herein by reference in its entirety.

### BACKGROUND OF THE INVENTION

Across the globe people are faced with many different options when it comes to making a decision. Whether it is buying a dress for a special evening, going to a ski resort for a winter holiday, purchasing a special gift for a loved one or simply deciding on the best restaurant for dinner out with friends.

Currently when people have to decide on something they turn to the Internet for information. They research websites and/or send email or text messages to people they trust or speak to them live or via social media. They use several different avenues to help make their decisions.

However, these methods suffer from a number of drawbacks. For example, they have to reach out individually to those who they trust the most. I.e., if they wish to send a text message to each person, then they are sending individual messages which may complicate keeping track of who has responded and who has not. Further, it is difficult to know who should receive reminders or prompts if they have not answered after a certain amount of time. Group text messages can be sent but results can be spread over multiple message and the results are not necessarily private. I.e., all group members may see the results.

In addition, the user may not be able to access the advice at a later time. In particular, oral advice may be forgotten and even written advice may be lost or swamped with future responses, forcing the user to search for the appropriate answers.

Accordingly, there is a need in the art for a system that can allow a user to reach out to selected individuals for assistance in making a decision. In addition, there is a need in the art for the system to allow a user to automatically send reminders to those who have not answered after a specified time. Further, there is a need in the art for an organized decision history which the user can access.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes, in a computing system allowing a user to seek assistance in making a decision from collaborators, a non-transitory computer-readable storage medium including instructions that, when executed by the computing system, performs the step receiving from a user a decision. The decision includes a deadline by which collaborators must respond. The non-transitory computer-readable storage medium also includes instructions that, when executed by the computing system, performs the steps allowing the user to choose collaborators and sending the decision to the collaborators. The non-transitory computer-readable storage medium further includes instructions that, when executed by the computing system, performs the steps receiving results from the collaborators and presenting results from the collaborators to the user.

Another example embodiment includes a method of allowing a user to ask selected collaborators to help in making a decision. The method includes a user preparing a decision. The method also includes the user setting the parameters of the decision. Setting the parameters of the decision includes setting a decision name, a deadline by which collaborators must respond and a reminder time. The method further includes the user choosing collaborators and sending the decision to the collaborators. The method additionally includes receiving results from the collaborators and presenting results from the collaborators to the user. The method moreover includes storing the results in a decision history for the user.

Another example embodiment includes a system for allowing the user to enlist the assistance of collaborators in making a decision. The system includes a first computing system. The first computing system is configured to allow a user to prepare a decision and set the parameters of the decision. The parameters of the decision include a decision name, a deadline by which collaborators must respond and a reminder time. The first computing system is also configured to allow a user to choose collaborators. The system also includes a database. The database stores the decision, sends the decision to the collaborators and stores a decision history for the user. The system further includes a second computing device. The second computing device is configured to allow a collaborator to view the decision, receive a reminder and respond to the decision. The database receives the response to the decision from the collaborator and presents the response to the user.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a system for allowing a user to enlist collaborators in making a decision;

FIG. 2 is a flowchart illustrating an example of a method of allowing a user to ask selected collaborators to help in making a decision;

FIG. 3 is a flowchart illustrating an example of a method of accumulating results from collaborators;

FIG. 4 illustrates an example of a mobile application which allows a user to present a decision to collaborators;

FIG. 5 illustrates an example of the mobile application allowing a user to set parameters of a decision;

FIG. 6 illustrates an example of the mobile application allowing a user to customize a decision;

FIG. 7 illustrates an example of the mobile application presenting a decision to a collaborator;

FIG. 8 illustrates an example of the mobile application presenting results to a user;

FIG. 9 illustrates an example of the mobile application presenting a decision history to a user; and

FIG. 10 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

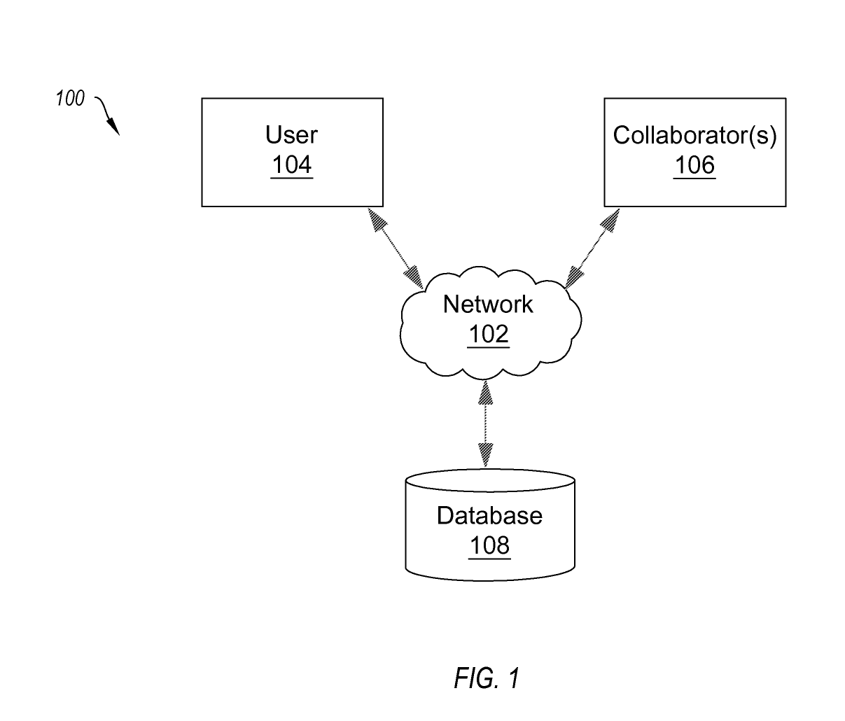

FIG. 1 illustrates a system 100 for allowing a user to enlist collaborators in making a decision. The decision can include any topic on which the user wishes to receive input. For example, the decision can include fashion choices, organizational choices or any other choice that the user wishes input on. One of skill in the art will appreciate that while decisions are often phrased as a question, which is used herein as exemplary, the decision is not restricted to those queries which are phrased as a question. I.e., the decision need not be phrased as a question.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include a user 104 connected to the network 102. The user 104 can include any entity connected over the network 102 which wishes to receive assistance regarding a decision. The entity can include a person, company, group organization or any other entity. For example, the user 104 can include a person who wants to ask friends to assist in making a decision. Alternatively, the user 104 could include a company that is looking for customer feedback regarding product lines or other corporate decision. In addition, the user 104 can include an electronic device used by the entity to access the network 102. For example, the user 104 can include a mobile device, computer, laptop, tablet, smart phone or any other electronic device.

FIG. 1 further shows that the system 100 can include a collaborator 106. The collaborator 106 can include any entity that the user wishes to enlist in making a decision. In particular, the user will post a decision or other decision that the user needs or wants to make. The collaborator 106 will then receive the decision over the network 102. The collaborator 106 can then respond in any manner that was allowed by the user when creating the decision. In addition, the collaborator 106 can include an electronic device used by the entity to access the network 102. For example, the collaborator 106 can include a mobile device, computer, laptop, tablet, smart phone or any other electronic device.

FIG. 1 also shows that the system 100 can include database 108. In at least one implementation, the database 108 can include any system capable of storing and retrieving the decision or past decisions, as described below. For example, the database 108 can include an electronic database capable of electronically storing data. E.g., the database 108 can include memory or memory banks capable of transitory or non-transitory storage. Additionally or alternatively, the database 108 can include processors or other logic devices capable of executing software or carrying out other computer algorithms. I.e., the database 108 can allow a user to access the hardware of the database 108 for remote computing or for information retrieval.

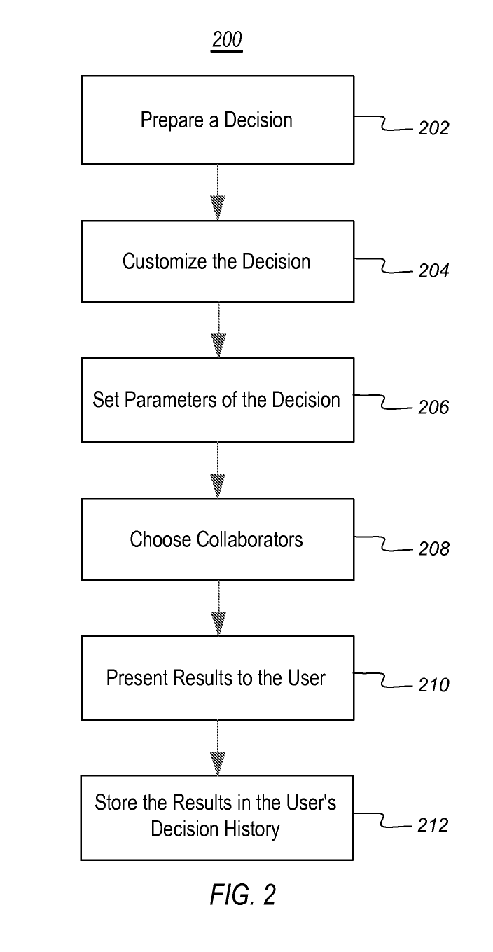

FIG. 2 is a flowchart illustrating an example of a method 200 of allowing a user to ask selected collaborators to help in making a decision. The method 200 can provide a means for the user to present the decision to the collaborators and to customize the decision, as described below.

FIG. 2 shows that the method 200 can include preparing 202 a decision. In particular, a user can prepare 202 a decision which he/she will then send to friends to gather their opinion. For example, the user can enter a custom decision by typing text into an electronic device. Additionally or alternatively, the user can select a decision from a decision library. The decisions stored in the decision library can be decisions used by the user previously or by other users.

FIG. 2 also shows that the method 200 can include customizing 204 the decision. Customizing 204 the decision can include any changes that the user wishes to make. For example, a decision from the decision library may include blank spaces or may include only a portion of the decision (e.g., the decision, but not possible answers) and the user inputs additional information. Additionally or alternatively, the decision can be customized 204 by adding additional information to the decision. For example, the user can add a target such as a database, webpage, website, domain, subdomain, web post, Uniform Resource Identifier (“URI”), Uniform Resource Locator (“URL”), non-permanent posting such as e-mail and chat, or other data located on or accessible through an intranet or over the Internet. Additionally or alternatively, the user can add a picture, video or any other relevant information. For example, the user can provide background information that may help in providing an opinion regarding the decision.

FIG. 2 further shows that the method 200 can include setting 206 parameters of the decision. Parameters of the decisions can include any properties that the user wishes to change. For example, the parameters of the decision can include a name of the decision. Naming the decision can allow the user to more easily reference the decision. Additionally or alternatively, the parameters of the decision can include decision groupings. For example, the user can assign the decision to a “wedding decision” group where the decisions all pertain the user's wedding.

In addition, parameters of the decision can include deadlines or other restrictions on when collaborators can provide an opinion. I.e., the user can set the decision to expire at a date and time, after which collaborators cannot provide answers or opinions. Moreover, the user can set a time or times when collaborators will receive a reminder. For example, the user can set an automatic reminder to be sent 24 hours before the deadline and an urgent reminder to be sent one hour before the deadline.

Moreover, parameters of the decision can include privacy settings. In particular, the user can determine whether collaborators are able to see the opinions provided by other collaborators and at which time they can be seen. For example, the user can allow all collaborators to see all responses or can allow collaborators to see only his/her own response. Additionally or alternatively, the user can allow collaborators to see how other collaborators have responded only after the deadline has passed or only after a collaborators has submitted his/her own response.

FIG. 2 additionally shows that the method 200 can include choosing 208 the collaborators. The collaborators can include any grouping that the user desires. For example, the user can select individuals from a contact list, social media connections (such as Facebook friends or Twitter followers) or from any other list. Additionally or alternatively, the user can select a preset group or create a group to which the decision will be sent. For example, the user can create a “wedding group” with collaborators who will assist in wedding decisions and a “fashion group” with collaborators who can provide input on every day fashion decisions, etc.

FIG. 2 moreover shows that the method 200 can include presenting 210 the results to the user. The results can be presented 210 in real time and/or after the deadline has passed. I.e., the user can be notified each time a collaborator responds, can log in and check results when desired, can be sent the results when the deadline has been reached (through whatever communication means that were set 206 previously) or can be allowed to long in and check results once the deadline has been reached.

FIG. 2 also shows that the method 200 can include storing 212 the decision in the user's decision history. The user can then review the decision and responses from the collaborators at his/her convenience. I.e., the user can save the decision and other decisions and responses. This can allow the user to review the advice given by the collaborators. For example, in response to a decision a collaborator may say “pick the green shirt, green really highlights your beautiful eyes.” The user can then review that response later when making other fashion decisions.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

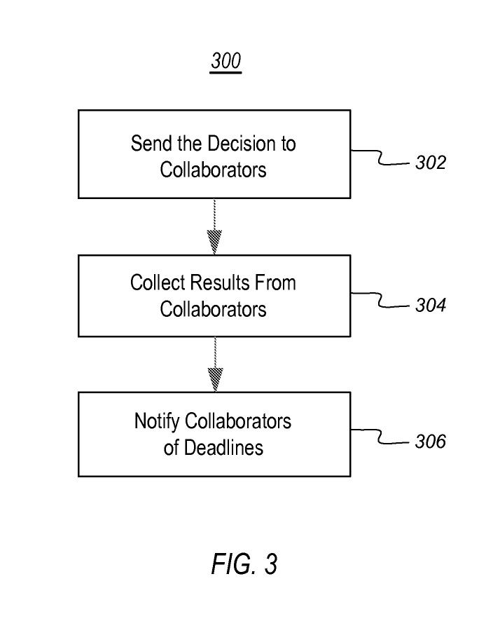

FIG. 3 is a flowchart illustrating an example of a method 300 of accumulating results from collaborators. The results can be accumulated to help the user make a decision. The results can be presented to the user in real-time (i.e., as collaborators provide responses) or after a deadline has passed (i.e., after the collaborators can no longer respond showing the cumulative results of all collaborators).

FIG. 3 shows that the method 300 can include sending 302 the decision to collaborators. The decision can be sent 302 through any desired method or by any desired communication means. For example, the decision can be sent 302 by email, text messaging, Facebook, Twitter, Pinterest or any other communication means or social media site. The decision which is sent 302 to the collaborators can include a response mechanism. For example, the decision can include a link which will take a collaborator to a webpage where the collaborator can enter his/her opinion. Additionally or alternatively, the collaborator can respond via the communication means or social media site. For example, if the collaborator is notified via email, the collaborator can respond to the email.

FIG. 3 also shows that the method 300 can include collecting 304 results from the collaborators. I.e., the response from various collaborators can be collected and organized. For example, if the decision includes multiple choice responses, the number of collaborators and/or the percentage which have selected a particular answer can be collected and calculated. The results can be collected 304 in real time or can be stored and organized as the deadline is reached.

FIG. 3 further shows that the method 300 can include notifying 306 collaborators of deadlines. The collaborators can be notified 306 in the original communication sent 302 to the collaborators. In addition, the collaborators can be notified 306 when the preset reminder times are reached. For example, if the user set a reminder for 24 hours before the deadline, a reminder can automatically be sent which notifies 306 the collaborators of the deadline. All collaborators can be notified 306 that the deadline is approaching or only those collaborators which have not responded can be notified 306.

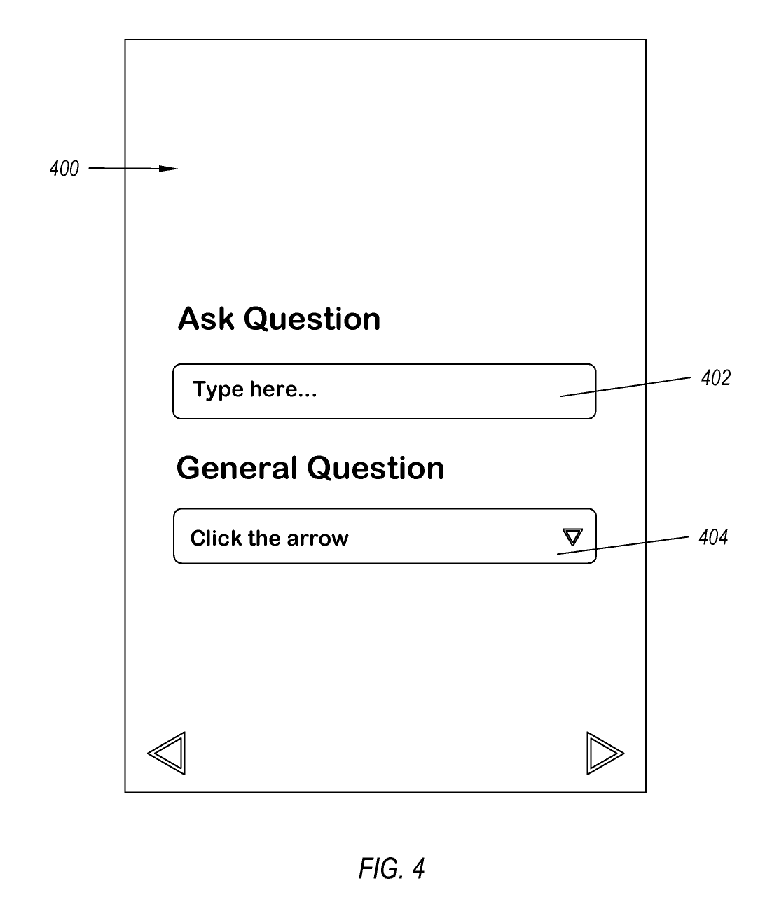

FIG. 4 illustrates an example of a mobile application 400 which allows a user to present a decision to collaborators. One of skill in the art will appreciate that although a mobile application 400 is shown herein, other applications are contemplated herein, as discussed above. The mobile application 400 allows the user to input a decision 402 and/or select a decision 404 from a decision library. The decision can then be further modified, as described above.

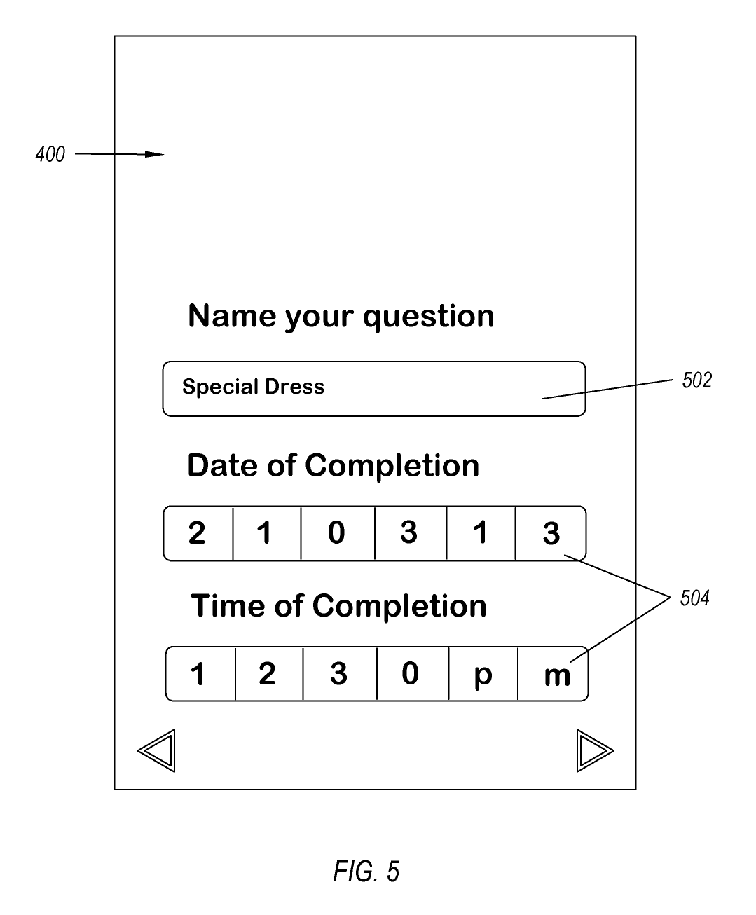

FIG. 5 illustrates an example of the mobile application 400 allowing a user to set parameters of a decision. For example, the user can name the decision 502. Naming the decision can allow the user to better locate decisions and to help collaborators understand the purpose of the decision. Additionally, the user can set a deadline 504 for the collaborators to provide a response.

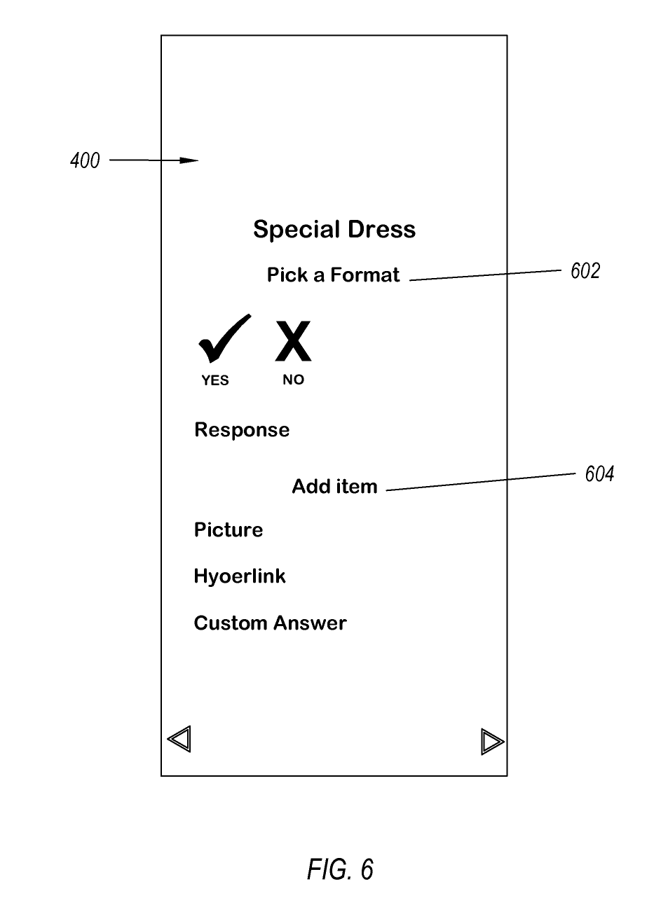

FIG. 6 illustrates an example of the mobile application 400 allowing a user to customize a decision. For example, the user can pick a format 602 for the decision, such as presenting possible responses or allowing a user to enter a response. Additionally, the user can add items 604 to the decision, such as a picture, a link or any other desired additional information.

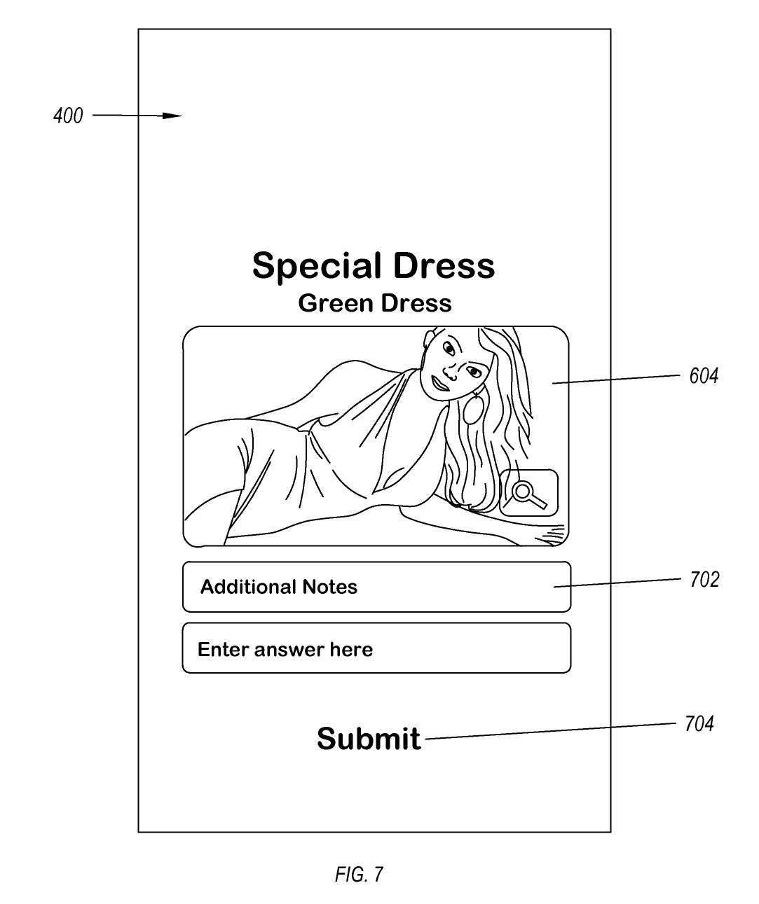

FIG. 7 illustrates an example of the mobile application 400 presenting a decision to a collaborator. The mobile application 400 can present the additional items 604 which were added by the user. Further, the mobile application 400 can allow the user to input responses 702 and to send the responses to the user 704. While the mobile application 400 can be one way in which the collaborator can respond, one of skill in the art will appreciate that the collaborator can respond in other ways, such as via a website or via social media, as described above.

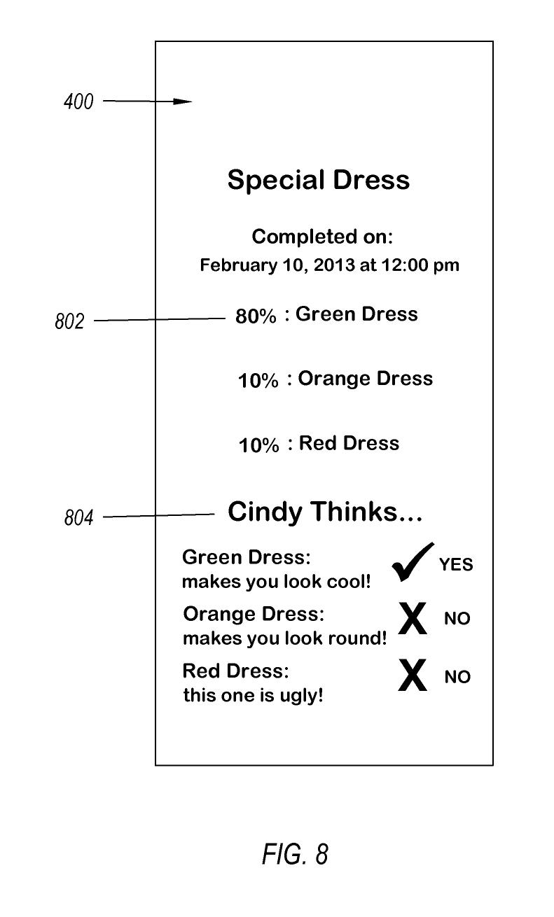

FIG. 8 illustrates an example of the mobile application 400 presenting results to a user. For example, the mobile application 400 can include the percentage of collaborators 802 that choose each option. I.e., the mobile application 400 can include the results from all collaborators 802. In addition, the mobile application 400 can present additional comments from individual collaborators 804. I.e., if a collaborator provided additional information beyond the options presented, that additional information can be presented to the user.

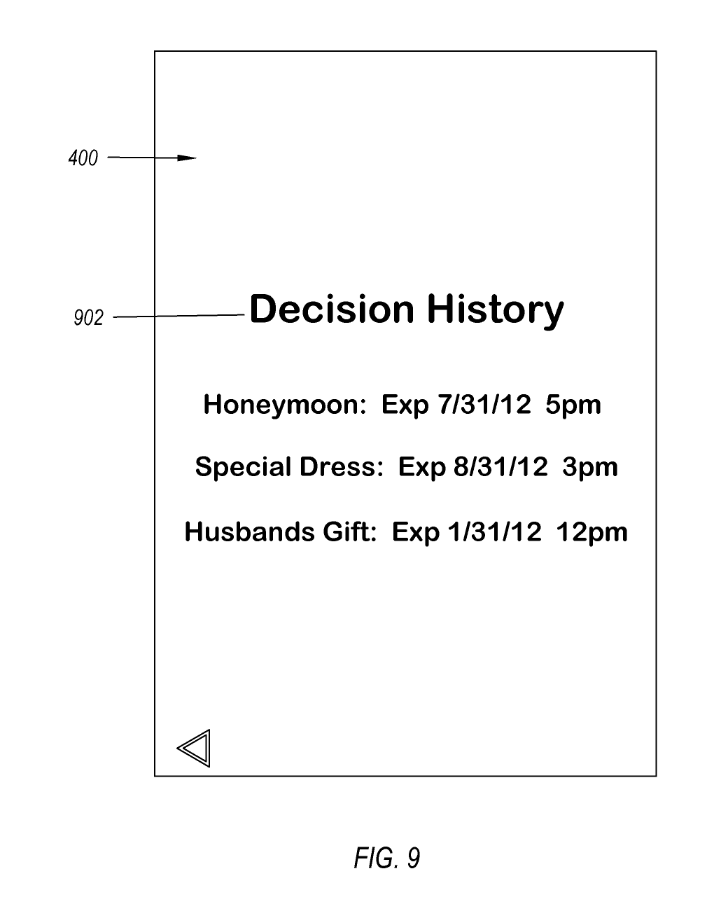

FIG. 9 illustrates an example of the mobile application 400 presenting a decision history 902 to a user. The decision history 902 can include decisions previously presented to decisions and/or current decisions which have not yet reached their deadlines. Moreover, the decision history 902 can include decision groups to allow the user to organize the decisions.

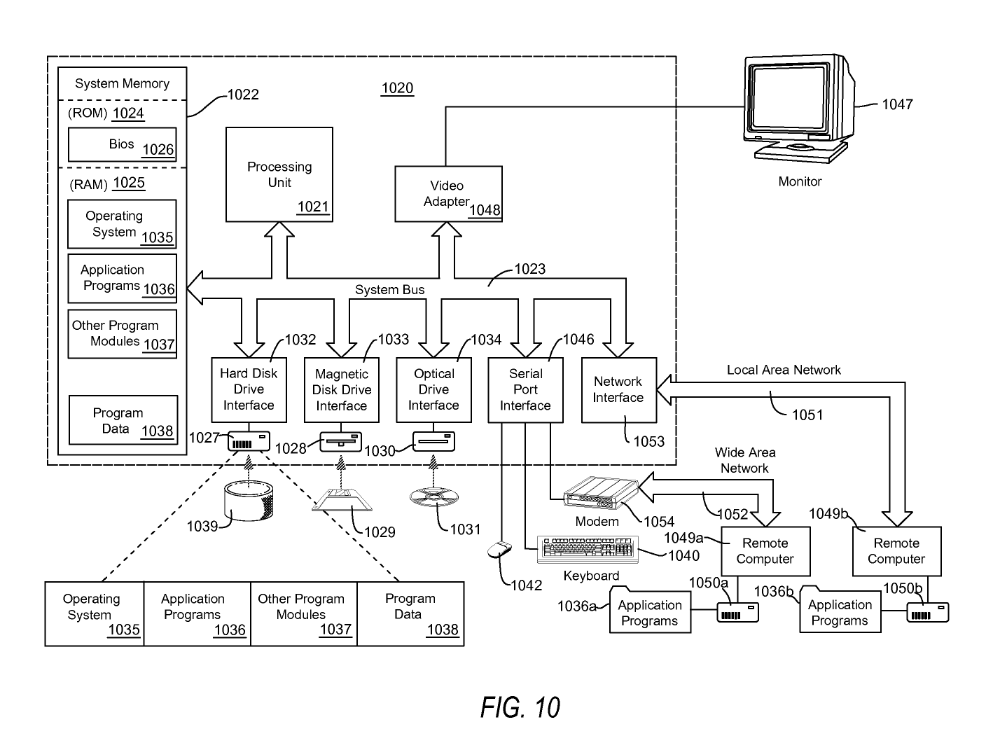

FIG. 10, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 10, an example system for implementing the invention includes a general purpose computing device in the form of a conventional computer 1020, including a processing unit 1021, a system memory 1022, and a system bus 1023 that couples various system components including the system memory 1022 to the processing unit 1021. It should be noted however, that as mobile phones become more sophisticated, mobile phones are beginning to incorporate many of the components illustrated for conventional computer 1020. Accordingly, with relatively minor adjustments, mostly with respect to input/output devices, the description of conventional computer 1020 applies equally to mobile phones. The system bus 1023 may be any of several types of bus structures including a memory bus or memory controller, a peripheral bus, and a local bus using any of a variety of bus architectures. The system memory includes read only memory (ROM) 1024 and random access memory (RAM) 1025. A basic input/output system (BIOS) 1026, containing the basic routines that help transfer information between elements within the computer 1020, such as during start-up, may be stored in ROM 1024.

The computer 1020 may also include a magnetic hard disk drive 1027 for reading from and writing to a magnetic hard disk 1039, a magnetic disk drive 1028 for reading from or writing to a removable magnetic disk 1029, and an optical disc drive 1030 for reading from or writing to removable optical disc 1031 such as a CD-ROM or other optical media. The magnetic hard disk drive 1027, magnetic disk drive 1028, and optical disc drive 1030 are connected to the system bus 1023 by a hard disk drive interface 1032, a magnetic disk drive-interface 1033, and an optical drive interface 1034, respectively. The drives and their associated computer-readable media provide nonvolatile storage of computer-executable instructions, data structures, program modules and other data for the computer 1020. Although the exemplary environment described herein employs a magnetic hard disk 1039, a removable magnetic disk 1029 and a removable optical disc 1031, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 1039, magnetic disk 1029, optical disc 1031, ROM 1024 or RAM 1025, including an operating system 1035, one or more application programs 1036, other program modules 1037, and program data 1038. A user may enter commands and information into the computer 1020 through keyboard 1040, pointing device 1042, or other input devices (not shown), such as a microphone, joy stick, game pad, satellite dish, scanner, motion detectors or the like. These and other input devices are often connected to the processing unit 1021 through a serial port interface 1046 coupled to system bus 1023. Alternatively, the input devices may be connected by other interfaces, such as a parallel port, a game port or a universal serial bus (USB). A monitor 1047 or another display device is also connected to system bus 1023 via an interface, such as video adapter 1048. In addition to the monitor, personal computers typically include other peripheral output devices (not shown), such as speakers and printers.

The computer 1020 may operate in a networked environment using logical connections to one or more remote computers, such as remote computers 1049a and 1049b. Remote computers 1049a and 1049b may each be another personal computer, a server, a router, a network PC, a peer device or other common network node, and typically include many or all of the elements described above relative to the computer 1020, although only memory storage devices 1050a and 1050b and their associated application programs 1036a and 1036b have been illustrated in FIG. 10. The logical connections depicted in FIG. 10 include a local area network (LAN) 1051 and a wide area network (WAN) 1052 that are presented here by way of example and not limitation. Such networking environments are commonplace in office-wide or enterprise-wide computer networks, intranets and the Internet.

When used in a LAN networking environment, the computer 1020 can be connected to the local network 1051 through a network interface or adapter 1053. When used in a WAN networking environment, the computer 1020 may include a modem 1054, a wireless link, or other means for establishing communications over the wide area network 1052, such as the Internet. The modem 1054, which may be internal or external, is connected to the system bus 1023 via the serial port interface 1046. In a networked environment, program modules depicted relative to the computer 1020, or portions thereof, may be stored in the remote memory storage device. It will be appreciated that the network connections shown are exemplary and other means of establishing communications over wide area network 1052 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system allowing a user to seek assistance in making a decision from collaborators, a non-transitory computer-readable storage medium including instructions that, when executed by the computing system, performs the steps:
receiving from a user a decision, wherein the decision includes:
a deadline by which collaborators must respond;
allowing the user to choose collaborators;
sending the decision to the collaborators;
receiving results from the collaborators; and
presenting results from the collaborators to the user.

2. The system of claim 1, wherein the results are presented to the user in real-time.

3. The system of claim 1, wherein the results are presented to the user after the deadline.

4. The system of claim 1 further comprising:
allowing the user to set parameters of the decision.

5. The system of claim 4, wherein the parameters include the deadline.

6. The system of claim 4, wherein the parameters include the name of the decision.

7. The system of claim 4, wherein the parameters include a decision group.

8. The system of claim 1 further comprising:
sending a reminder to any collaborator who has not responded before a preset time.

9. The system of claim 1 further comprising:
presenting a decision history to the user.

10. A method of allowing a user to ask selected collaborators to help in making a decision, the method comprising:
a user preparing a decision;
the user setting the parameters of the decision, wherein setting the parameters of the decision includes setting:
a decision name;
a deadline by which collaborators must respond; and
a reminder time;
the user choosing collaborators;
sending the decision to the collaborators;
receiving results from the collaborators;
presenting results from the collaborators to the user; and
storing the results in a decision history for the user.

11. The method of claim 10, wherein the user choosing collaborators includes:
the user selecting a pre-set group of collaborators.

12. The method of claim 10, wherein allowing the user to choose collaborators includes:
allowing the user to select from a contact list.

13. The method of claim 10, wherein the contact list includes:
a list of social media connections.

14. The method of claim 10 further comprising:
customizing the decision, wherein customizing the decision includes:
adding a picture to the decision.

15. The method of claim 10 further comprising:
customizing the decision, wherein customizing the decision includes:
adding a URL to the decision.

16. The method of claim 10 further comprising:
customizing the decision, wherein customizing the decision includes:
preparing possible responses from the collaborators.

17. A system for allowing the user to enlist the assistance of collaborators in making a decision, the system comprising:
a first computing system, wherein the first computing system is configured to allow a user to:
prepare a decision;
set the parameters of the decision, wherein the parameters of the decision include:
a decision name;
a deadline by which collaborators must respond; and
a reminder time;
choose collaborators;
a database, wherein the database:
stores the decision;
sends the decision to the collaborators; and
stores a decision history for the user; and
a second computing device, wherein the second computing device is configured to allow a collaborator to:
view the decision;
receive a reminder; and
respond to the decision;
wherein the database:
receives the response to the decision from the collaborator; and
presents the response to the user.

18. The system of claim 17, wherein preparing the decision includes choosing from a decision library on the database.

19. The system of claim 17, wherein preparing the decision includes the user entering a free form decision.

20. The system of claim 17, wherein the decision is sent to the collaborator using at least one of:
email;
text message;
Facebook;
Twitter;
Pinterest; or
social media.
